(19) United States
(12) Patent Application Publication
(10) Pub. No.: US 2023/0169531 A1
(43) Pub. Date: Jun. 1, 2023

(54) METHOD AND APPARATUS FOR MOTION DATA ANALYSIS

(71) Applicant: XPLORA TECHNOLOGIES AS, Oslo (NO)

(72) Inventors: Sten Kirkback, Ranheim (NO); Sanghyo Kim, Greater London (GB)

(73) Assignee: XPLORA TECHNOLOGIES AS, Oslo (NO)

(21) Appl. No.: 17/921,923

(22) PCT Filed: Apr. 26, 2021
(86) PCT No.: PCT/GB2021/051007

§ 371 Date: Oct. 27, 2022

(30) Foreign Application Priority Data
Apr. 29, 2020 (GB) 2006303.8

(51) Int. Cl. G06Q 30/0208

(52) U.S. Cl. CPC G06Q 30/0208

(57) ABSTRACT

A method of motion data analysis includes collecting movement data (10) of a user using a motion sensor (6) in a user device (2), processing, by a processor (14), the movement data (10) of the user and outputting a value of a motion parameter, and transmitting the value of the motion parameter to a remote server (16). The method further includes the remote server (16) outputting a confidence value representing a confidence that the value of the motion parameter is accurate, based on second data stored in the remote server (16), wherein the second data is a different type of data to the data collected using the motion sensor (6). If the confidence value exceeds a threshold, the remote server (16) converts the value of the motion parameter into a value representing an amount of a currency using a pre-defined exchange rate. The currency is arranged to be usable on other devices.

### BACKGROUND OF THE INVENTION

This invention relates to a device and a method for analysing motion data of a user, for example the number of steps made by a user.

It is known in the art for devices to include GPS and motion sensors, and for data from these sensors to be processed in an effort to derive information about a user's physical activity. For example, there are known watch-type devices which are designed to be worn on the wrist of a user, and which provide the user with an indication of the “number” of steps that they have completed on a given day.

The present invention seeks to provide an improved device and method for motion data analysis.

### SUMMARY OF THE INVENTION

From a first aspect, the invention provides a method of motion data analysis, comprising:
collecting movement data of a user using a motion sensor in a user device;
processing, by a processor, the movement data of the user and outputting a value of a motion parameter;
transmitting the value of the motion parameter to a remote server;
outputting, by the remote server, a confidence value representing a confidence that the value of the motion parameter is accurate, based on second data stored in the remote server, wherein the second data is a different type of data to the data collected using the motion sensor; and,
if the confidence value exceeds a threshold, the remote server converting the value of the motion parameter into a value representing an amount of a currency using a pre-defined exchange rate, wherein the currency is arranged to be usable on other devices.

According to a second aspect, the invention provides a remote server, arranged to carry out the method of motion data analysis described herein. Thus, there is provided a remote server, arranged to carry out the steps of:
receiving a value of a motion parameter;
outputting, by the remote server, a confidence value representing a confidence that the value of the motion parameter is accurate, based on second data stored in the remote server, wherein the second data is a different type of data to the data collected using the motion sensor; and,
if the confidence value exceeds a first threshold, the remote server converting the value of the motion parameter into a value representing an amount of a currency using a pre-defined exchange rate, wherein the currency is arranged to be usable on other devices.

From a third aspect, the invention provides a motion data analysis system, comprising:
a user device arranged to be carried by a user, the user device comprising a motion sensor arranged to collect movement data of the user;
the motion data analysis system further comprising a processor, configured to process the movement data of the user and output a value of a motion parameter; and
a remote server, arranged to store second data, wherein the second data is a different type of data to the data collected using the motion sensor, wherein the motion data analysis system is arranged so that the value of the motion parameter is transmitted to the remote server, and wherein the remote server is arranged to output a confidence value representing a confidence that the value of the motion parameter is accurate, based on the second data, and, if the confidence value exceeds a threshold, to convert the value of the motion parameter into a value representing an amount of a currency using a pre-defined exchange rate, wherein the currency is arranged to be usable on other devices.

Thus it will be seen that, in accordance with the invention, by having the remote server output a confidence value representing a confidence that the derived motion parameter value is accurate, based on second data, the remote server is able to provide a certain level of “validation” to the motion parameter, to ensure that the amount of currency, derived from the motion parameter, is accurate. This helps to provide a system in which currency can be generated from user activity in a manner which is accurate, such that the system cannot easily be “tricked” with false or inaccurate user movement data. This is beneficial since it prevents currency being provided in exchange for falsified motion data, whilst allowing genuine user activity to be rewarded with currency, thereby encouraging and motivating user activity.

In some embodiments the user device is integrated within a wearable device which is worn by the user. For example, in some embodiments, the user device may be a smart watch or activity tracking watch e.g. arranged to be worn by the user. The user device may be a stand-alone motion sensor e.g. arranged to be attached to the user's body, for example the user's wrist or ankle, during exercise. Alternatively, the user device may be a mobile communication device or smart phone e.g. arranged to be carried by the user or worn in a particular item of clothing e.g. a pocket or arm-band. Although referred to as a “user” device, the device may also be arranged to monitor another being or thing, for their activity e.g. an animal tracker or bicycle tracker.

The user device comprises the motion sensor arranged to collect movement data of the user. The motion sensor may for example be an accelerometer.

The movement data of the user is then processed, by the processor, to provide a motion parameter. The motion parameter is a metric of the activity carried out by the user, for example, the motion parameter could include the distance travelled by the user and/or the time spent exercising by the user. In some embodiments, the motion parameter is the number of steps taken by the user in a defined time period.

It will be understood that at certain times a user may be constantly moving, such that their movement data and consequently the value of the motion data parameter is constantly changing. In some embodiments, the value of the motion parameter may be transmitted to the remote server continuously. However, in order to keep the value stored in the remote server up to date at all times, near constant data transmission would be required, which would consume a very large amount of very power. It has been appreciated that periodic transmission is typically sufficient to still provide a satisfactory user experience, since the user will only check the value of their motion parameter at certain intervals e.g. check their step count after a long walk, and even then the value need only be approximately correct. Thus, in some embodiments, the value of the motion parameter is transmitted to the server periodically. The skilled person will understand by this that the motion parameter value is transmitted at substantially regular intervals, such that it may not permanently be fully up to date. The data may be transmitted once every 24 hours, every 1 hour, every 1 minute, or every few seconds. Furthermore, the amount of the currency may likewise only be calculated periodically, optionally at each instance of the motion parameter value being received at the remote server. The user will usually not attempt to use the currency immediately after completing user activity, and therefore some delay is acceptable.

The user device itself may contain the processor. For example if the user device is a mobile communication device, it may have sufficient processing power to process the movement data of the user and output a value of the motion parameter, directly to the remote server. This helps to minimise the number of components required to carry out the method.

Alternatively, the processor may be located on an intermediate device. For example, the user device may be a simple sensor device including a transmitter, e.g. not containing a processor capable of processing the movement data. The simple user device may then transmit the collected motion data to the processor on the intermediate device, and the intermediate device may then process the motion data to output a motion parameter, and transmit this value to the remote server. The intermediate device may be a mobile device e.g. smart phone of a user. This advantageously allows the user device to be a simple and low cost device, and makes use of processing power already existing in a user device.

Further alternatively, the remote server may contain the processor. The user device may be arranged to transmit the collected movement data of the user directly to the remote server for processing, or the user device may be arranged to transmit the collected movement data to an intermediate device e.g. a mobile device, and the intermediate device may be configured to forward to movement data to the remote server e.g. without processing the movement data of the user to output a motion parameter.

The user device, processor, remote server, and any additional intermediate device may be arranged to communicate using any suitable manner of communication. They need not all communicate using the same manner of communication. They could for example use a combination of Bluetooth, WiFi, LTE and physical or wired connections.

The remote server is arranged to output a confidence value representing a confidence that the value of the motion parameter is accurate. The confidence value is based on second data stored in the remote server and the second data is a different type of data to the data collected using the motion sensor. In some embodiments, the second data comprises second sensor data. The second data may comprise data from a single sensor or from multiple sensors. The multiple sensors may include one arranged to sense the same parameters (which helps to provide redundancy), or they may sense only different parameters. The second sensor may be one or more sensors each arranged to sense one of: distance travelled, location or heart-rate of the user. Thus, the method may comprise the second sensor sensing distance travelled, location or heart-rate of the user. The second data may therefore comprise location data, distance data and/or heart rate. For example, if the derived motion parameter value indicates that the user has completed a large amount of steps, but the reading of the heart rate indicator indicates a very low heart rate, then the confidence value for the motion parameter value may be assigned a low value.

Additionally or alternatively, the second data may comprise data relating to the particular user device. In particular, the second data may include the status of certain parameters, for example whether or not the user device is charging, and/or whether or not the user device is in proximity e.g. being worn by, the user. In some examples, the confidence value could thus be assigned as low in the instance where the second data indicates that the device is charging, since it is unlikely, if not impossible, that a user genuinely completed the activity whilst the user device was tethered to a charging device. In some embodiments, the user device may be arranged to allow the user to input and/or store user parameters. For example, the user parameters may include the age, gender, and fitness level of the user.

The second sensor may be arranged to sense second data relating to the particular user of the user device i.e. the same user for whom the motion parameter value is calculated. Thus in some embodiments, the motion data analysis system comprises a second sensor. Optionally the user device comprises the second sensor. In these embodiments, the user device may be configured to transmit the second sensor data to the remote server, optionally the user device may be configured to transmit the second sensor data to the processor and the processor may be configured to transmit the second sensor data to the remote server. Similarly, therefore, the method may further comprise the user device transmitting the second sensor data to the remote server. Alternatively, the user device may not comprise the second sensor. Rather, the second sensor may be part of a separate sensing device e.g. a separate external sensor worn by the user e.g. on a wristband, or a sensor located in a separate user device e.g. a mobile device or telephone. The second sensor may therefore separately transmit second sensor data to the remote server, either directly, or via the processor.

In some embodiments, the second data stored on the remote server is historical data. The historical second data may relate to second sensor data. For example, the second data may relate to values of the distance travelled, by the user, over elapsed periods of time. For example, the historical data may indicate the distances covered by the user, when the motion parameter reaches a certain value, and this may be compared with current motion parameter values and second sensor data to give a confidence value. For example, if a user previously travelled 5km in carrying out 5000 steps then a motion value parameter of 10,000 steps may be given a high confidence value if the second sensor data now indicates that approximately 10 km have been travelled by the user. Additionally, the second data may also include historical data relating to values of the motion parameter, for the user, over elapsed periods of time. This allows the confidence value to be determined by comparing whether the currently measured value of the motion parameter e.g. number of steps, appears to be reasonable or reliable, based on the previous values determined for this same user. For example, if a user previously averaged 5000 steps a day, and on one particular day the motion parameter indicates that 20,000 steps have been completed, this data may receive a lower confidence value.

In some embodiments, additionally or alternatively, the second data is community data e.g. it does not relate only to the particular user of the user device, but is collected from other users. This second data, collected from other users, may be collected under standardised test conditions e.g. in a laboratory setting. However, it is advantageously data which is collected from a plurality of other user devices, during normal use by the respective users. This advantageously helps to represent all different environments and conditions of normal users more accurately than standardised conditions, and provides a constantly growing supply of user data for analysis, thereby providing more reliable and accurate analysis. Thus, the method may further comprise collecting second data from a plurality of other users. Similarly the second data may be data relating to a plurality of other users The second data may be data relating to recorded second sensor data for a plurality of users and/or any other type of data collected in relation to the other. Additionally, the second data may also be data relating to the recorded motion parameter values for a plurality of users.

The remote server may additionally store at least one user parameter relating to the other users (e.g. as part of the second data). User parameters may include the age, gender, and fitness level of a user. The second data may be categorised based on the at least one user parameter e.g. into data relating to user sub-groups. The outputting by the remote server of a confidence value may be based specifically on second data relating to other user data wherein the other user's parameters meet a specific criterion i.e. wherein the users belong to a particular sub-group. In particular, a user parameter may be determined for the user of the user device, and the second data which is used may correspond to second data from users having the same or similar user parameters. For example, a gender and age bracket may be determined for the user of the user device, and in determining the confidence value, the server may use community second data relating specifically to users having the same gender and belonging to the same age bracket. This further improves the accuracy of the confidence value which is determined, since the data which is used is selected to be particularly relevant to the user.

As described above, the second data may be a variety of different data e.g. second sensor data or other data relating to the user of the user device and/or relating to a plurality of other users e.g. community data (and optionally, additionally, historical motion parameter values). This data may be used by the remote server to output a confidence value for the derived motion parameter. In some embodiments, the remote server derives this confidence value by creating a predicted relationship between the motion parameter and the second data. Thus, in these embodiments, the remote server is arranged to analyse the sample data and create a predicted relationship, between the motion parameter and the second data.

The confidence value may then be determined based on a comparison between the derived motion parameter value and the predicted relationship. For example, the method may further comprise predicting a value of the motion parameter using the predicted relationship and second data collected in relation to the user, and comparing the predicted value of the motion parameter with the value of the motion parameter derived from the movement data of the user. In some embodiments, the comparing comprises calculating a difference between the predicted value of the motion parameter with the value of the motion parameter derived from the movement data of the user e.g. calculating the residual value. In some embodiments, the confidence value is representative of the difference. The confidence value may be the difference itself, or may be derived from the difference using one or more processing steps, for example normalisation.

The confidence value may be derived using a plurality of sets of second data. For example, the sets of second data could each be data collected from a plurality of second sensors, or could be community data relating to a plurality of separate parameters. In some embodiments, a plurality of confidence sub-values may be calculated, each in the way described herein and using a plurality of different respective second data sets. In some examples, a further confidence sub-value may be calculated using historical motion parameter value data.

The confidence value may then be calculated by combining the confidence sub-values. For example, the confidence value may be calculated by taking an average (e.g. a mean value) of at least two confidence sub-values.

If the confidence value exceeds a threshold, the remote server converts the value of the motion parameter into a value representing an amount of a currency using a pre-defined exchange rate. There may be just a single pre-defined exchange rate or, alternatively, the pre-defined exchange rate may be selected depending upon the derived confidence value. For example, the exchange rate may be proportional to the confidence value (provided that the confidence value threshold is exceeded). Alternatively, there may be at least two threshold values, such that if the confidence value exceeds a first threshold, the motion parameter is converted to a currency value using a first exchange rate, and if the confidence value exceeds a second threshold, the motion parameter is converted to a currency value using a second exchange rate. The second threshold may be higher than the first threshold, and the second exchange rate may be higher than the first exchange rate.

The pre-defined exchange rate may depend on other parameters, in addition or alternatively to depending on the confidence value (provided that the threshold is exceeded). For example, the user device may be arranged to determine the particular type of activity which the user undertakes, for example whether the user is running outdoors, running on a treadmill, or walking. Different pre-defined exchange rates may be defined for different types of activity. For example, even for the same value of the motion parameter e.g. number of steps, running may correspond to a higher pre-defined exchange rate than walking, and may therefore earn the user more virtual currency than walking.

The motion data analysis system may additionally be arranged to allow the user to generate an amount of the currency based on other user activity parameters, in addition to the motion parameter described above. For example, the motion data analysis system may be arranged to determine the location of the user (for example using a GPS sensor included in the user device) and to convert an amount of time spent in a pre-defined location e.g. a library or a museum, into an amount of a currency, using a second pre-defined exchange rate. Additionally, or alternatively, users may be allowed to exchange currency with each other or to purchase currency using externally recognised currency e.g. US dollars.

The currency is arranged to be usable on other devices. Thus, once the remote server calculates the amount of the currency, this value may be stored on the remote server and/or transmitted to the user device and/or a further device e.g. a mobile device or smart phone. The transmitted currency amount may be linked e.g. by an identifier, to a particular user or a particular user device. The user may be able to access this currency amount on multiple devices, for example by logging in to a user account, wherein the currency is stored in association to the particular user account.

The currency may be used by a user for virtual purchases e.g. for an avatar associated with their user account, or for purchases within a virtual game. Additionally, or alternatively, the currency may be able to be used on devices (both the user device and/or additional devices) to make non-virtual purchases. Thus, the method according to the present invention may comprise a user exchanging the currency for goods, optionally non-virtual goods. This helps to provide additional motivation to the user to be active, since they are incentivised both by virtual purchases but also by “real world” purchases e.g. merchandise and sport related goods, which they are able to purchase with their virtual currency, earned through physical activity. The motion data analysis system disclosed herein is particularly important and useful in this context, since the user is effectively earning money through their physical activity and so it is likely that certain users will attempt to falsify user activity data. Thus is it particularly advantageous that the present invention provides a system and method for verifying such user activity data, and awarding currency accordingly.

Features of any aspect or embodiment described herein may, wherever appropriate, be applied to any other aspect or embodiment described herein. Where reference is made to different embodiments or sets of embodiments, it should be understood that these are not necessarily distinct but may overlap.

### BRIEF DESCRIPTION OF THE DRAWINGS

Certain preferred embodiments of the invention will now be described, by way of example only, with reference to the accompanying drawings, in which:

FIG. 1 is a schematic drawing showing a motion data analysis system according to an embodiment of the present invention;

FIG. 2 is a graph showing an example set of second data, relating motion parameter value data on a specified day to motion parameter value data averaged over a week;

FIG. 3 is a graph showing another example set of second data, relating motion parameter value data on a specified day to distance data;

FIG. 4 shows the graph of FIG. 3, in which the shade of each data point is used to illustrate its respective confidence value;

FIG. 5 is a graph showing calculated residual values for an example data set;

FIG. 6 is a graph illustrating an example confidence value, calculated from a second data set relating motion parameter value data to distance data;

FIG. 7 is a graph illustrating an example confidence value, calculated from a second data set relating motion parameter value data to time data;

FIG. 8 is a graph illustrating an example confidence value, calculated from a second data set relating motion parameter value data to heart rate data; and

FIG. 9 is a flow chart illustrating a method of motion data analysis according to an embodiment of the present invention.

### DETAILED DESCRIPTION

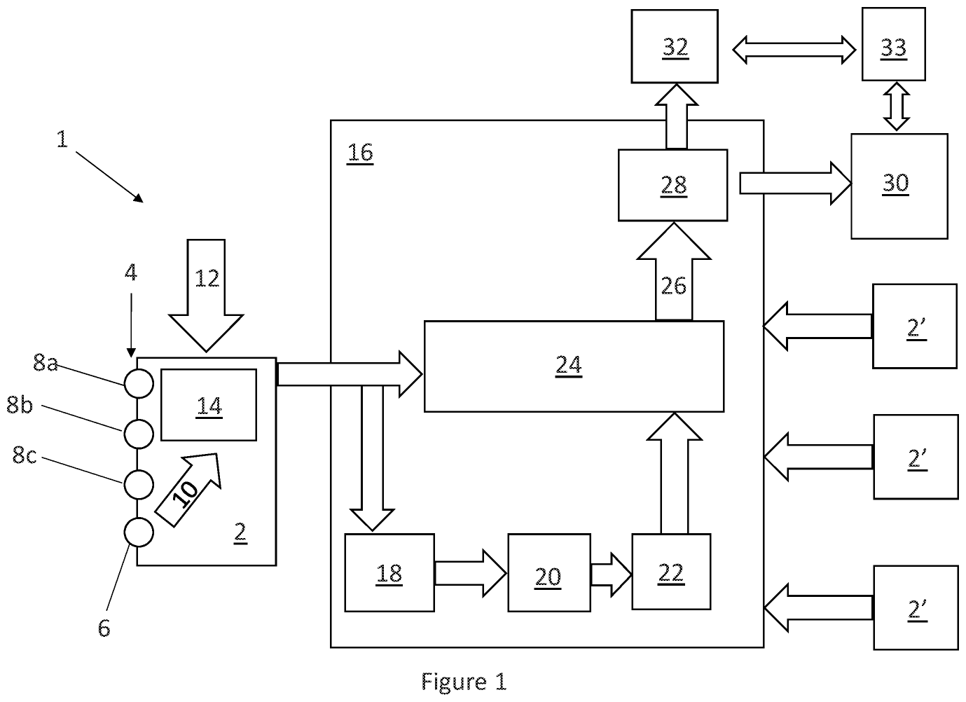

FIG. 1 is a schematic drawing showing a motion data analysis system 1 according to an embodiment of the present invention. The motion data analysis system 1 includes a user device 2 including a processor 14, and a remote server 16. The processor 14 is shown in FIG. 1 as being located within the user device 2, however this is not essential. The processor 14 could be located in an intermediate device, for example a mobile device or computer, or could be located in the remote server.

The user device 2 could be for example a smart watch e.g. a fitness tracker watch. The user device 2 could alternatively be a mobile smartphone, carried by the user. The user device 2 includes a plurality of sensors 4. These sensors 4 include specifically a motion sensor 6, which is arranged to collect movement data 10 of the user. In the example as shown, the motion sensor 6 is an accelerometer. The motion sensor 6 is arranged to collect the movement data of the user, and this data is then sent to the processor 14, optionally periodically, which processes this data to output a value of a motion parameter. The motion parameter in this example is the number of steps carried out by the user.

The user device 2 also includes second sensors 8a, 8b, 8c comprising a GPS location sensor 8a, which allows the location of the sensor to be determined, a heart rate sensor 8b monitoring the user's heart rate, and a distance or proximity sensor 8c, which may for example monitor for proximity to the user and check whether the user is wearing the user device.

The user device 2 also comprises a user input interface, which allows a user to provide user input data 12. This allows the user to provide further data which may be relayed to the remote server and may be used in determining the confidence value. For example, the user may provide their age, gender and fitness level. The user may provide an input which indicates the type of activity which they are going to participate in.

The motion data analysis system 1 includes a plurality of other user devices 2′, which have some or all of the same components as described in reference to user device 2. Each other user device 2′ transmits data to the remote server 16 as shown.

The motion data analysis system 1 also includes a remote server 16. The remote server 16 includes a data analyser module 24. The data analyser module 24 processes the motion parameter value calculated by the processor 14 and outputs a confidence value 26, representing a confidence that the value of the motion parameter is accurate. The remote server also includes a data storage module 18, data miner module 20 and statistical database 22.

The confidence value 26 used by the remote server 16, specifically a currency calculation module 28, to calculate a currency value. The currency calculation module 28 checks that the confidence value 26 exceeds a certain “base” threshold, and provided it does, then the currency calculation module 28 converts the motion parameter value e.g. the number of steps into a currency value. The calculated currency value is then transferred to, for example, a game server 30 and/or a virtual shop 32. End users can then use this currency value to access digital content, purchase merchandise, or exchange it for other currencies even using other devices 33 in communication with the servers 30, 32. In this context, the present data verification method is particularly important, in order to improve the reliability of the converted currency value.

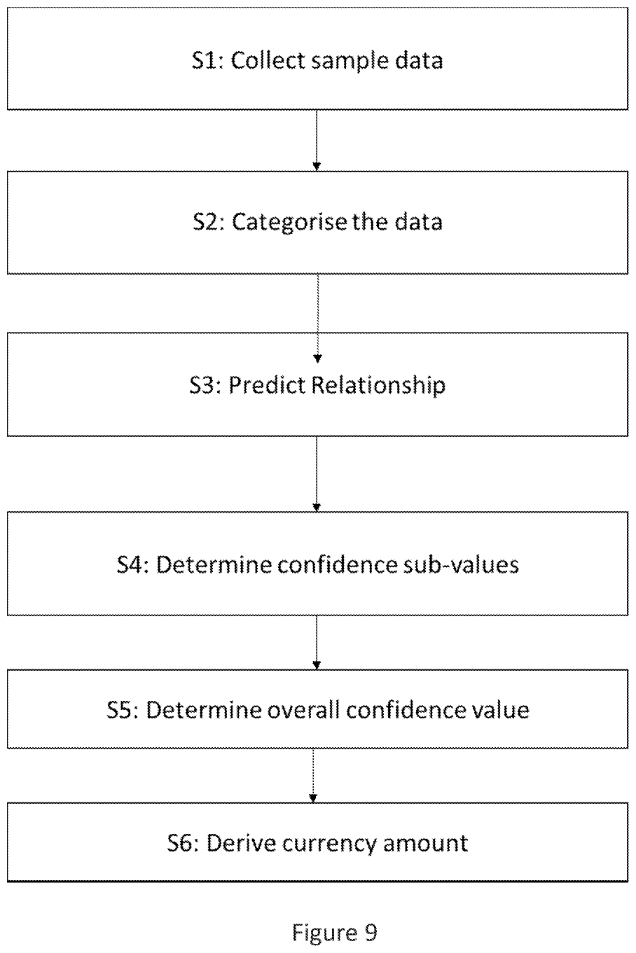

In accordance with the system described above, the flow chart of FIG. 9 shows the stages of a corresponding method of motion data analysis according to an embodiment of the present invention.

The first stage of the motion data analysis, at step S1, is to collect sample data, to be stored in the data storage module 18. The sample data can therefore form part of the historical data used to analyse subsequent motion data from the user of the specific user device 2, and other users and user devices 2′. The data includes movement and motion parameter value data from the accelerometer 4, together with data collected from a plurality of other sensors 8a, 8b, 8c, and other data available from the device e.g. user input 12 and any other known data e.g. time and date.

The next step S2 is to use the data miner module 20 to categorise and process this collected data. For example, the data may include user parameters such as age and gender, and these user parameters are then used at step S2 to sort the collected data into sub-groups.

Then, for each of these sub-groups, the data is analysed by the data miner module 20. In particular, various relationships can be predicted between the motion data parameter e.g. the number of steps, and all of the stored data. This includes both historical step count data, but also all of the other types of collected data e.g. the predicted relationship between movement time and number of steps. These relationships are all predicted at step S3 and stored in the statistical database 22.

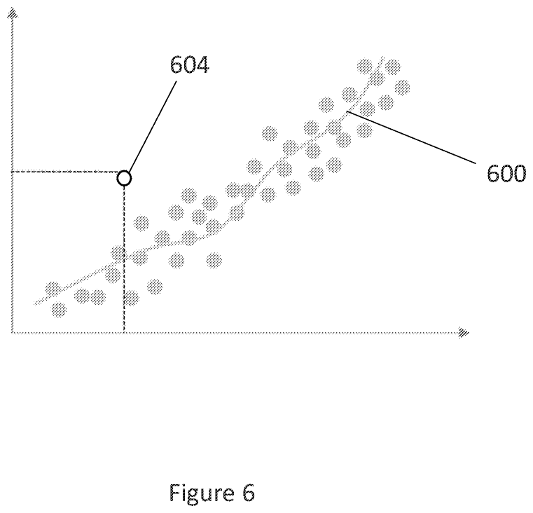

A particular data set which is to be analysed is then collected, e.g. data relating to a particular user device and a particular activity session. Thus, the motion sensor 6 of the user device 2 collects movement data 10, and this movement data 10 is then processed by the processor 14, which outputs a value of a motion parameter (e.g. a step count). This value of the motion parameter, together with other user device data, is then transmitted to the remote server 16. For this particular data set the data analyser module 24 then determines the appropriate set of predicted relationships, based on that user's parameters using data from the statistical database 22. Using various different parameters of this particular data set, the data analyser module 24 calculates a series of confidence sub-values at step S4. For example, as described below in relation to FIGS. 6, 7 and 8. These confidence values are determined based on the deviation of the collected data from the predicted relationships (for the user's particular sub-group).

At step S5, the various confidence sub-values are combined in order to determine an overall confidence value. Any suitable average can be used, for example a simple mean of the confidence values. This overall confidence value represents a confidence that the value of the motion parameter is accurate.

Finally, at step S6, the overall confidence value is compared to a threshold. If the confidence value exceeds that threshold then the currency calculation module 28 converts the value of the motion parameter into a value representing an amount of a currency using a pre-defined exchange rate. There could be multiple thresholds, each associated with different exchange rates. This currency is then usable on other devices, for example a user may use a mobile communication device or computer 33 to access game server 30 or virtual shop 32 and make purchases using their currency. The processing by the data analyser module 24 relies on second data, also referred to as statistical data which is stored in the statistical database 22. As previously mentioned, the statistical data stored in statistical database 22 is obtained by the remote server 16, by first storing data received from the user device 2 in the data storage module 18, and then processing this data through the data miner module 20, to extract useful statistical relationships. The data miner module 20 is programmed to discover patterns in large data and build up knowledge for data analysis and decision support. The data miner module 20 also filters and refines the data to extract a more reliable sample data. Data received from a particular user device 2 can then be compared with this second data, stored in statistical database 22, by the remote server 16, to give the confidence value.

The data stored in the data storage module 18 can be any useful or possibly relevant data which the remote server 16 receives. Firstly, with regard to a single user device 2 as shown, the remote server 16 receives, either directly or via the processor 14, the data from accelerometer 6, GPS location sensor 8a, a heart rate sensor 8b and distance or proximity sensor 8c (indicating whether the user or other monitored person or object is in proximity i.e. wearing the device). The remote server 16 also receives other i.e. non-sensor data from the user device 2, for example indicating, for a given time period, whether the user device 2 was being charged, and possibly indicating other known parameters e.g. the weather conditions at a user's location. All data received may also include a time and a date stamp, this also allows the duration of activities to be determined. The data transmitted to the remote server may also include additional further user input data 12. This is data provided by the user by means of the user device 2. The user may for example indicate the type of activity they are about to carry out, their gender, age and fitness level, or any other relevant information.

Furthermore, there are a plurality of other user devices 2′, all sending data to the remote server 16 to be stored in the database 22. The data stored in database 22 therefore includes all of the data listed above, not only for a single user device, but for a plurality of other such user devices e.g. even from completely unrelated users and user devices.

The data miner module 20 can use the user input information, and also the other data supplied by each user device, to categorise, filter and analyse the received data. For example, the data miner module 20 may break the data down into sub-groups for different age categories, and separated by gender. If the data is categorised then the data analyser module 24 will only use data stored in the statistical database 22 which relates to the same sub-group as the particular user, when calculating a confidence value for that particular user. This provides improved accuracy.

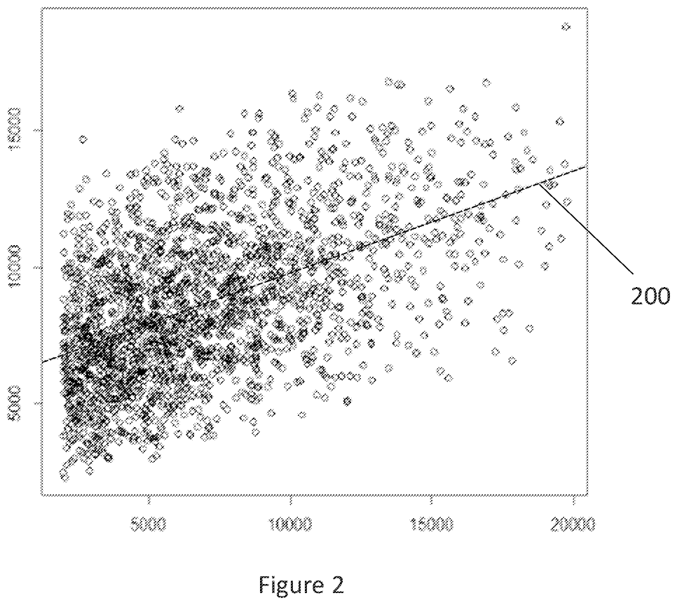

An example set of second data, stored in the statistical database 22 is shown in the graph of FIG. 2. This graph shows a relationship between the number of steps carried out by a user on a Monday (along the x-axis) compared to the average number of steps carried out in that same week (along the y-axis). Each data point seen in the graph relates to a different week, but the data points could also relate to many different users. The dashed line 200 represents a predicted relationship e.g. a regression model, or line of best fit, which has been calculated for this data set. This could be calculated using any suitable method, such as a line of best fit.

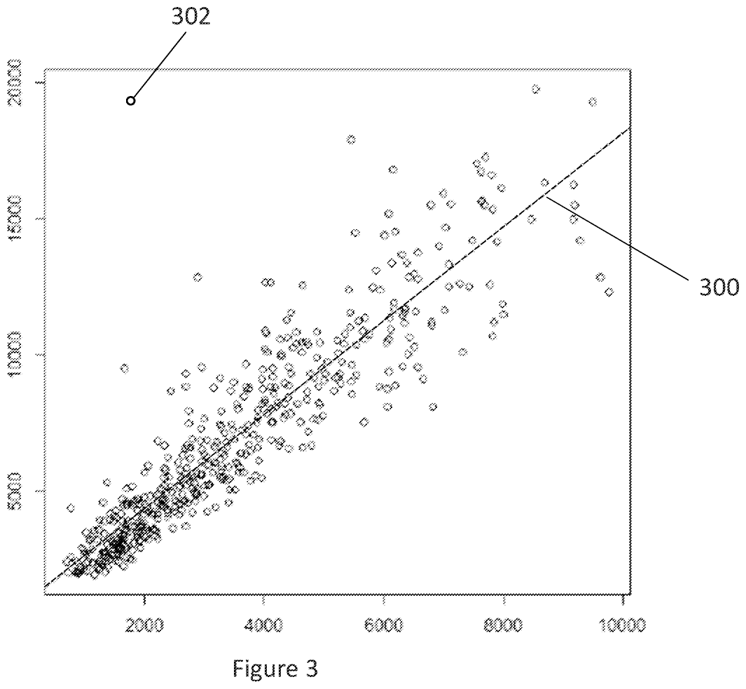

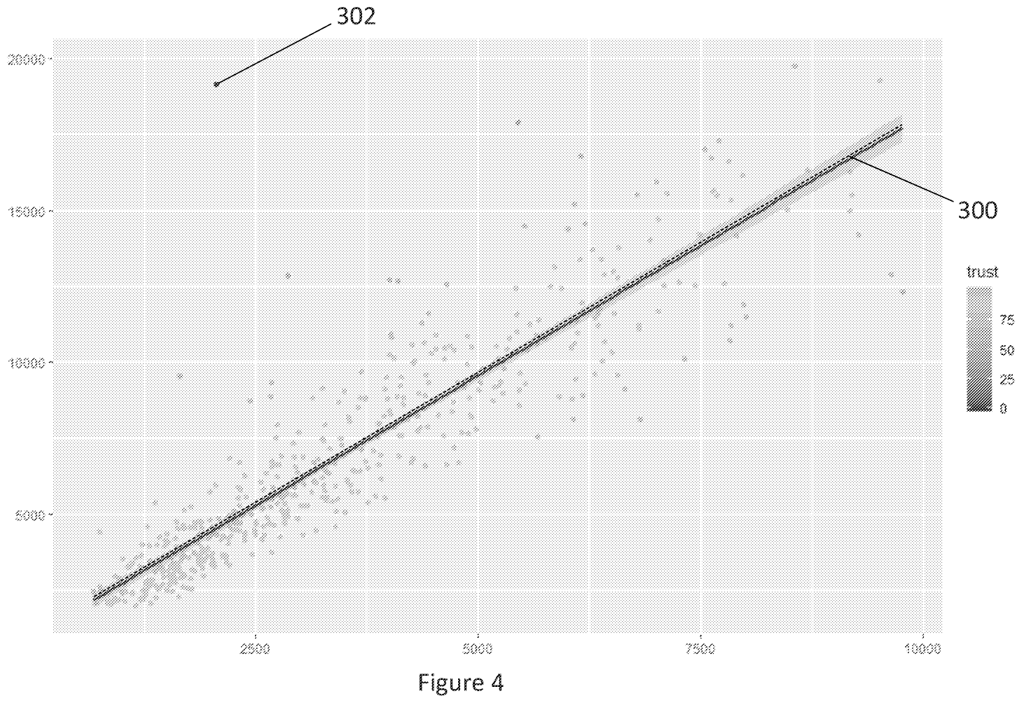

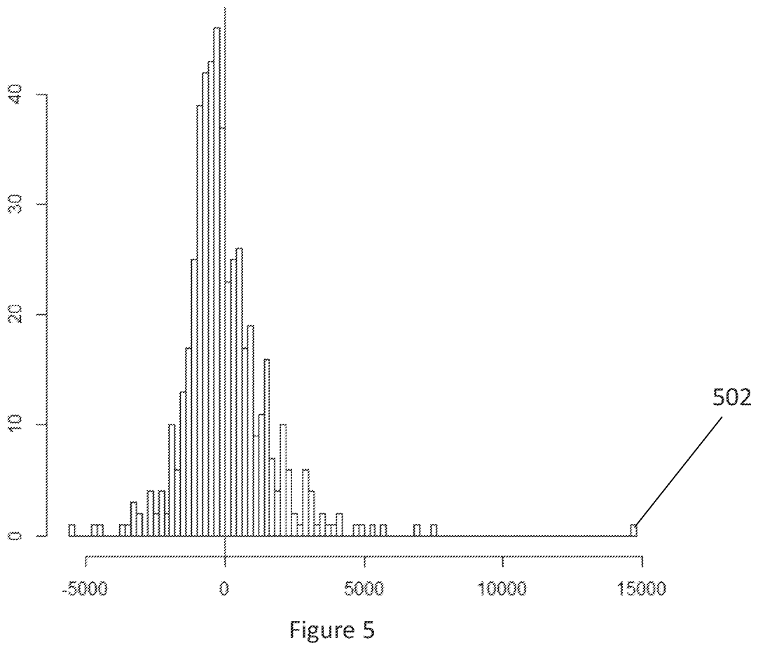

FIG. 3 is a graph showing another example set of second data, stored in the statistical database 22. This graph shows a relationship between the average distance travelled by the user on a given day e.g. a Monday (along the x-axis) compared to the average number of steps taken by the user on that day (along the y-axis). The data points shown on the graph are taken from a plurality of different users, all within the same user “sub-group” e.g. female users aged 25-30. The dashed line 300 shows a predicted relationship e.g. regression model or line of best-fit, which has been calculated for the data set. Additionally, a particular data point 302 is visible on this graph. This data point 302 is considered to be a statistical outlier, and will be discussed further in relation to FIG. 4 and FIG. 5.

FIG. 4 shows the graph of FIG. 3 in which the data points have been shaded using the “trust” scale shown to the right of the graph, to demonstrate the relative confidence in the validity of each data point. The outlier 302 can be seen and is clearly much darker than all of the other data points which are largely grouped around the predicted relationship line 300. Although it is not clearly visible in greyscale, the data points grouped together close to the lower end of the predicted relationship line 302 are the lightest, with the more spread apart data points in the middle of the graph being darker the further they are from the line 300. One possible method of determining a confidence value is based on which percentile of this ratio data (i.e. the ratio of step count to average distance) a user's data lies in.

One possible method of establishing the confidence values illustrated in FIG. 4 will now be described with reference to FIG. 5. FIG. 5 is a graph showing calculated residual values for an example data set. The residual value for a given data point is the error of that point in the data set compared to a prediction made using a model.

Firstly, the predicted relationship 200, 300 is determined using a regression model. Then, the residual value can be calculated as the difference between the value predicted by the relationship 302, with the actual value in the data set. So, if the model predicted that the user would have y amount of steps based on their x amount of distance, the difference between this prediction and the actual data are the residual values. The reliability percentage is then calculated based on the residual values, for example using any suitable normalisation process. In this example, the reliability percentage is calculated by subtracting the absolute value of the residual value from the absolute value of the maximum residual, and multiplying this difference by 100. FIG. 5 demonstrates the frequency of occurrence (y-axis) of different regression values (x-axis) for the data points shown in FIGS. 3 and 4. In accordance with the colour scale seen in FIG. 4, it is clear that the residual values are very low for the vast majority of the data points, however there are a small number of data points in the “wings” of the distribution which have a high residual value and are therefore highly unlikely to be valid. These data points would therefore be assigned a very low confidence value. For example, the data point 502 corresponds to the outlier 302 seen in FIGS. 3 and 4. Thus the residual values as illustrated in FIG. 5 give a percentage confidence value which gives an estimation of how far off this user's behaviour is within the total collection of sample data (in this case the sample in the same sub-group as the user). In some examples, the confidence value or sub-value may be determined based on the percentile of the residual distribution (as shown in FIG. 5) in which a particular data point lies. This percentile value may be inverted e.g. so that 0=very low confidence, 100=very high confidence).

FIGS. 6, 7 and 8 demonstrate example data sets, showing the predicted relationship for those variables, and a particular data point for which the data set has been used to calculate a confidence value.

FIG. 6 is a graph showing a second data set relating motion parameter value data e.g. step data (y-axis) to distance data (x-axis). The predicted relationship 600 has been calculated. The confidence value of the particular data point 604 has been calculated using the predicted relationship 604 in the technique described above. In the example as demonstrated, the confidence value of the data point 604 is determined to be 76.4%.

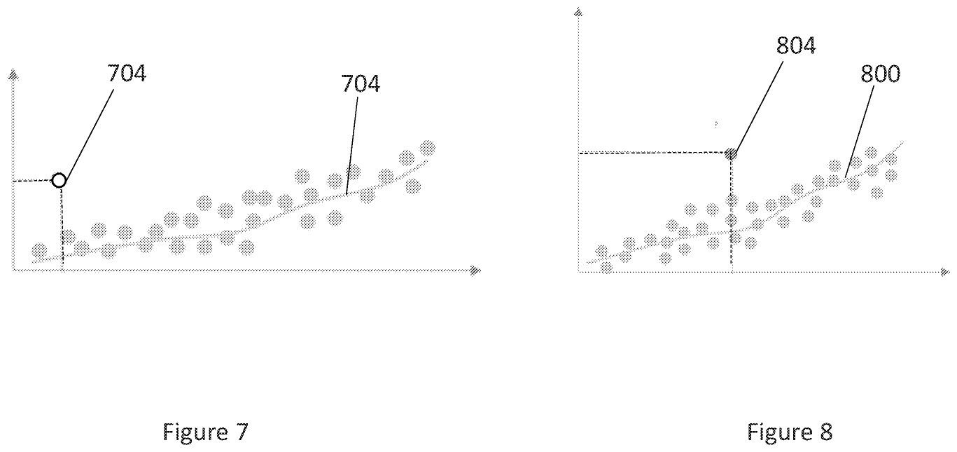

FIG. 7 is a graph showing a second data set relating motion parameter value data e.g. step data (y-axis) to lapsed time data (x-axis). The predicted relationship 700 has been calculated. The confidence value of the particular data point 704 has been calculated using the predicted relationship 700 in the technique described above. In the example as demonstrated, the confidence value of the data point 704 is determined to be 55%.

FIG. 8 is a graph showing a second data set relating motion parameter value data e.g. step data (y-axis) to heart rate data (x-axis). The predicted relationship 800 has been calculated. The confidence value of the particular data point 804 has been calculated using the predicted relationship 800 in the technique described above. In the example as demonstrated, the confidence value of the data point 804 is determined to be 65%.

In one example, these data points could all relate to the same particular user data set i.e. to the same particular activity and total motion parameter value e.g. step count. Therefore, for this particular session of activity, the confidence value of the step count can be determined by using additionally the distance data, the time data, or the heart rate data, taken together with the value of the step count. Either a single one of these confidence values (determined using data other than the movement data) could be chosen, or the various confidence values (also referred to as confidence sub-values) could be combined using blended data analysis.

Thus, each of the three calculated confidence sub-values (calculated for the graphs shown in FIGS. 6, 7 and 8) are combined, for example by calculating a mean (although any suitable combination or average can be used) to give an overall confidence value of 65%. This blended data analysis can also take into account other factors, such as whether the device was charging or in proximity of a user, and adjust the confidence value accordingly. For example, if it is detected that the device is charging, the confidence value might be significantly reduced or even dropped to zero, as it is highly unlikely, if not impossible, for the user device to record genuine and valid user activity whilst also tethered to a charging device.

It will be appreciated by those skilled in the art that the invention has been illustrated by describing one or more specific embodiments thereof, but is not limited to these embodiments; many variations and modifications are possible, within the scope of the accompanying claims.

1. A method of motion data analysis, comprising:
collecting movement data of a user using a motion sensor in a user device;
processing, by a processor, the movement data of the user and outputting a value of a motion parameter;
transmitting the value of the motion parameter to a remote server;
outputting, by the remote server, a confidence value representing a confidence that the value of the motion parameter is accurate, based on second data stored in the remote server, wherein the second data is a different type of data to the data collected using the motion sensor; and,
if the confidence value exceeds a threshold, the remote server converting the value of the motion parameter into a value representing an amount of a currency using a pre-defined exchange rate, wherein the currency is arranged to be usable on other devices.

2. The method of motion data analysis of claim 1, wherein the motion parameter is the number of steps taken by the user in a defined time period.

3. The method of motion data analysis of claim 1, wherein the second data comprises second sensor data.

4. The method of motion data analysis of claim 3, wherein the method further comprises the second sensor sensing distance travelled, location or heart-rate of the user.

5. The method of motion data analysis of claim 1, wherein the second data comprises data relating to the particular user device.

6. The method of motion data analysis of claim 1, wherein the second data is community data and wherein the method further comprises collecting second data from a plurality of other users.

7. The method of motion data analysis of claim 1, further comprising the remote server storing at least one user parameter, and categorising the second data based on the at least one user parameter.

8. The method of motion data analysis of claim 7, wherein the outputting by the remote server of a confidence value is based on second data relating to other user data meeting a specific criterion.

9. The method of motion data analysis of claim 1 wherein the second data stored on the remote server is historical data.

10. The method of motion data analysis of claim 1, further comprising the remote server analysing the sample data and creating a predicted relationship between the motion parameter and the second data, and comparing the derived motion parameter value and the predicted relationship in order to determine the confidence value.

11. The method of motion data analysis of claim 1, further comprising the remote server calculating a plurality of confidence sub-values, using a plurality of different respective second data sets, and calculating the confidence value by combining the confidence sub-values.

12. The method of motion data analysis of claim 1, comprising selecting the pre-defined exchange rate depending upon the derived confidence value.

13. The method of motion data analysis of claim 1, comprising defining different pre-defined exchange rates for different types of activity.

14. The method of motion data analysis of claim 1, further comprising determining the location of the user and converting an amount of time spent in a pre-defined location into an amount of a currency, using a second pre-defined exchange rate.

15. The method of motion data analysis of claim 1, wherein the currency is able to be used on devices to make non-virtual purchases.

16. A remote server, arranged to carry out the steps of:
receiving a value of a motion parameter;
outputting, by the remote server, a confidence value representing a confidence that the value of the motion parameter is accurate, based on second data stored in the remote server, wherein the second data is a different type of data to the data collected using the motion sensor; and,
if the confidence value exceeds a first threshold, the remote server converting the value of the motion parameter into a value representing an amount of a currency using a pre-defined exchange rate, wherein the currency is arranged to be usable on other devices.

17. The remote server of claim 16, wherein the remote server is arranged to store at least one user parameter, and wherein the second data is categorised based on the at least one user parameter.

18. The remote server of claim 17, wherein the remote server is arranged to output the confidence value based on second data relating to other user data meeting a specific criterion.

19. (canceled)

20. (canceled)

21. (canceled)

22. (canceled)

23. A motion data analysis system, comprising:
a user device arranged to be carried by a user, the user device comprising a motion sensor arranged to collect movement data of the user;
the motion data analysis system further comprising a processor, configured to process the movement data of the user and output a value of a motion parameter; and
a remote server, arranged to store second data, wherein the second data is a different type of data to the data collected using the motion sensor, wherein the motion data analysis system is arranged so that the value of the motion parameter is transmitted to the remote server, and wherein the remote server is arranged to output a confidence value representing a confidence that the value of the motion parameter is accurate, based on the second data, and, if the confidence value exceeds a threshold, to convert the value of the motion parameter into a value representing an amount of a currency using a pre-defined exchange rate, wherein the currency is arranged to be usable on other devices.

24. The motion data analysis of claim 23, wherein the user device is a smart watch or activity tracking watch.

25. The motion data analysis system of claim 23, wherein the motion sensor is an accelerometer.

26. The motion data analysis system of claim 23, wherein the user device comprises a second sensor, arranged to sense one of: distance travelled, location or heart-rate of the user.

27. The motion data analysis system of claim 23, wherein the user device is arranged to allow the user to input and/or store user parameters.
